(19) United States
(12) Patent Application Publication
(10) Pub. No.: US 2002/0142750 A1
(43) Pub. Date: Oct. 3, 2002

(54) Content for rental property

(76) Inventor: Earl F. Gill III, Pittsboro, NC (US)

Correspondence Address: COATS & BENNETT, PLLC, P O BOX 5, RALEIGH, NC, 27602, US

(21) Appl. No.: 09/819,576

(22) Filed: Mar. 28, 2001

(51) Int. Cl. H04N 7/16; G06F 17/60; H04M 11/00

(52) U.S. Cl. 455/406; 455/409; 705/34

(57) ABSTRACT

A set top box and remote may be positioned in a rental property with a payment acceptor. A renter may selectively purchase content for a television therethrough without having an account pre-established with the content provider. The landowner may receiver a fee for the referral.

### BACKGROUND OF THE INVENTION

1. Field of the Invention

The present invention relates to a device and technique for providing selective access to premium content on televisions located in rental property.

2. Description of the Related Art

Since their introduction, televisions, perhaps more than almost any other device, have proliferated throughout society. Most Americans receive news, entertainment, and other content from their televisions. From the few initial broadcast stations, content providers have likewise proliferated both in number and in ways in which content is delivered to the television. Cable systems, once thought to constitute the essence of a copyright violation, exist in virtually every community. Satellite systems exist for those people who are out of reach of the nearest cable system, people who are looking for competitive pricing structures, or the like.

With the advent of cable companies came the growth of premium channels such as HBO, CINEMAX, SHOWTIME, and the like. Close behind these creatures came pay per view events. Wrestling, in particular, seems to have a new pay per view event every month, while movies enjoy a last huzzah as pay per view events before being released to the premium movie channels.

Television has, in short, become an integral part of many peoples' lives, creating a demand well acknowledged by content providers. Hotels and motels are likewise cognizant of this demand. Many such establishments advertise “Free cable” or even “Free HBO” to travelers in an attempt to capture their business. Some establishments have opted to pass the cost to the consumer through the price of the room, but others take the process one step further, providing pay per view movies in the rooms. The consumer selects a movie and the cost is charged to the room. When the consumer checks out, the account is settled. The establishment pays the appropriate royalties, if any, and realizes a nice profit. The ease with which such transactions are accomplished is effectuated in part by the economy of scale of the establishment, and the well established check out procedures. Further, each room may have a virtual account in the computer system of the establishment, making tracking and provision of services relatively simple.

While hotels and motels are fine for many purposes, there is another breed of rental property that operates under different guidelines. For example, in many resort communities such as the Outer Banks, Hilton Head, and the like, home owners may rent their beach homes for blocks of time, be it a weekend, a week, or a month. This is true of not just beach communities, but also skiing communities and other resort areas. Such rental arrangements usually involve the landowner collecting an initial fee and a damage deposit. The landowner may, or may not, contract with a cable or satellite company to provide content to the property during the stay of the renters.

A shortcoming of this situation is that renters of such property may have a desire to see particular events that are not carried on the landowner's cable package. For example, an individual from Buffalo may wish to see the Buffalo Sabres's play off games while vacationing in the Outer Banks. The vacationer may even be willing to pay a premium to view the game. Unless the local cable or satellite company offers these games, the vacationer is heretofore out of luck.

Still another problem may exist in that vacationers frequently do not know anything about the area in which they are vacationing. They may not know which restaurants are good, where the restaurants are, or other information about the services available within the vacation community. While printed vacation guides are sometimes available, these may not be in a format that many people find convenient to use.

Thus, there remains a need for rental property to provide content to renters, without the need for pre-established accounts.

### SUMMARY OF THE INVENTION

The present invention places a set top box or other piece of equipment in a piece of rental property. This equipment includes some form of payment acceptor and communicates with a content provider. A renter of the property may use the piece of equipment to purchase selective access to content from the content provider without the need for a pre-established account with the content provider. The payment is made to the content provider, and the landowner may receive a fee for the referral.

In one embodiment, the renter may purchase from one of a plurality of predetermined packages, such as sports, news, movies, or the like. Further, in addition to the television content, the renter may purchase Internet access, game time, or other content as needed or desired.

In another embodiment, the piece of equipment may include a memory device that includes video commercials or geographically related web pages for goods or services available within the community. Instead of getting commercials for a Chicago restaurant while vacationing in Nags Head, the vacationer may instead access a commercial for a local eatery.

### BRIEF DESCRIPTION OF THE DRAWINGS

FIG. 1 illustrates a television with a set top box and remote for use with the present invention;

FIG. 2 illustrates a schematic diagram of one embodiment of the network connections between the rental property and the content provider;

FIG. 3 illustrates a flow chart diagram of one embodiment of using the present invention by a landowner;

FIG. 4 illustrates a flow chart diagram of one embodiment of using the present invention by a renter;

FIG. 5 illustrates a flow chart diagram of one embodiment of using the present invention by a content provider; and

FIG. 6 illustrates a flow chart diagram of one embodiment of using the present invention to retrieve information about local goods and services.

### DETAILED DESCRIPTION OF THE INVENTION

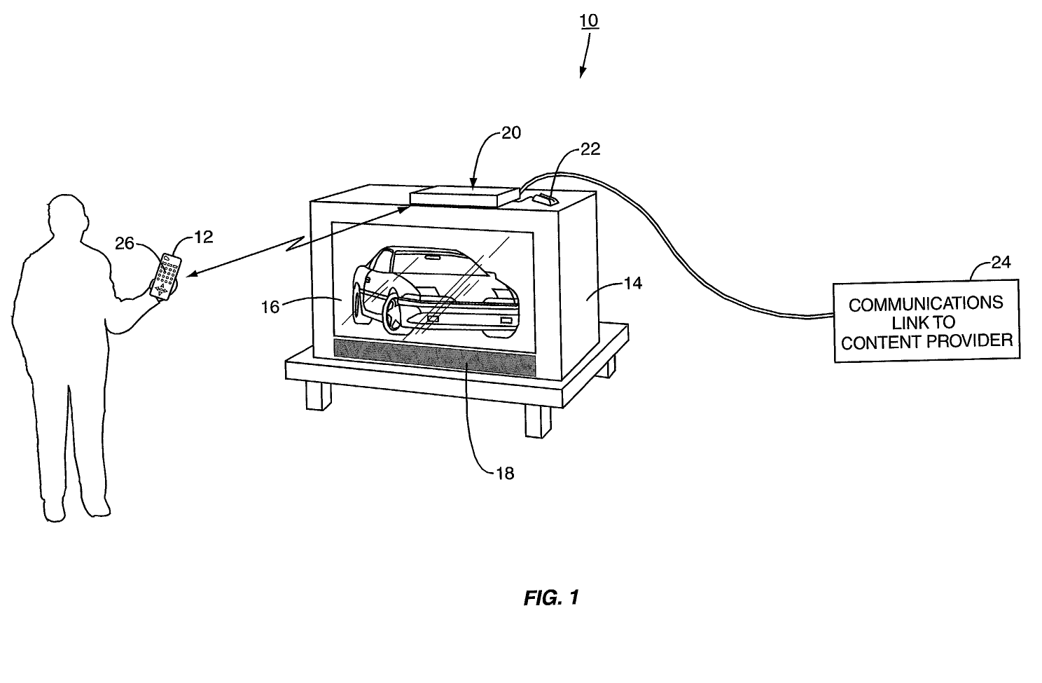

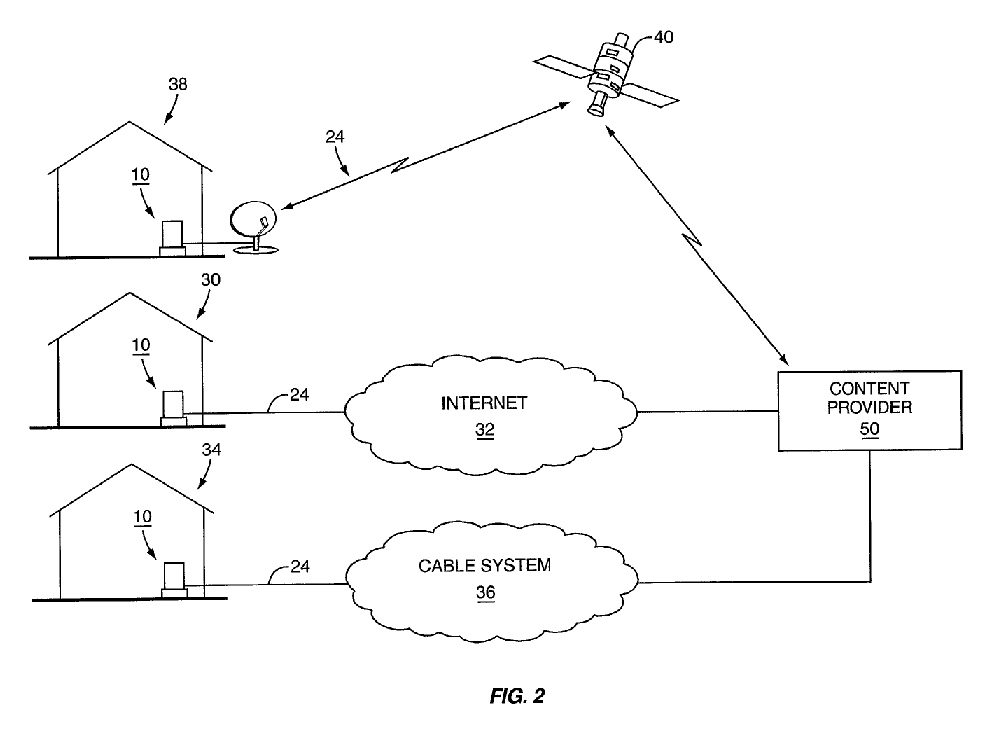

The present invention is designed to deliver content to renters of rental property while providing income to the content provider and potentially the rental property managers. To that end, the present invention may utilize some hardware as illustrated in FIGS. 1 and 2.

FIG. 1 illustrates a home entertainment system 10 comprising a remote control device 12, a television 14, and a set top box 20. Television 14 may comprise a display 16 and speakers 18 (only one shown). Set top box 20 may comprise a payment acceptor 22 and a communication link 24. Remote control device 12 may include a keypad 26 and control both television 14 and set top box 20. If need be the remote control device 12 may be a universal type remote. Additionally, remote control device 12 may have a payment acceptor integrated therein. An exemplary version of such a remote is seen in U.S. Pat. No. 5,603,078, which is herein incorporated by reference. As another embodiment, remote control device 12 may comprise a keyboard, either wired or wireless. It should be appreciated that keypad 26 includes both a numeric keypad such as is commonly found on conventional television remotes and alphanumeric keypads found on keyboards as well as other equivalent structures.

It should be appreciated that much as cable set top boxes 20 were initially discrete units, but have since been integrated into the television, set top box 20 may likewise be integrated into the television 14 if needed or desired, although this integrated version also falls within the definition of “set top box” as that term is used herein.

Communication link 24 is illustrated in its various permutations in FIG. 2. Home entertainment unit 10 is positioned in one of a plurality of houses, such as internet equipped house 30 linked to the internet 32, cable equipped house 32 linked to a cable system 36, or a satellite equipped house 38 linked to a satellite system 40. Note that the internet 32 may include cable systems 36 and/or satellite system 40 and cable systems 36 may likewise include internet 32 and/or satellite systems 40. In both of these cases, however, the user may not be aware of the integration of the systems 32, 36, 40, and may merely think of themselves as a cable subscriber or a satellite subscriber. Regardless of the actual communication link 24, the primary requirement of the communication link 24 is to allow bi-directional communication with a content provider 50. At least the content provider 50 to home entertainment system 10 link should be relatively high bandwidth, and it may be advantageous to have the home entertainment system 10 to content provider 50 link be high bandwidth as well, although such is not required. Set top boxes 20 may have addresses that differentiate one from another. Possible addressing techniques may comprise telephone numbers, IP addresses, unique identifiers hardwired into the circuitry of the set top box 20 comparable to Mobile Identification Numbers (MIN) used in cellular phones, programming cards such as are used in satellite receivers, and the like.

Content provider 50 may comprise a computer and include input devices, output devices, an input/output interface, a central processing unit, network interface, and memory as is well understood. The input/output devices may be various and sundry, including, but not limited to, a keyboard, a mouse, a joystick, a trackball, electronic stylus, a scanner, a microphone, speakers, camera, display, or the like. The central processing unit may be a single processor or a plurality of processors. Examples of appropriate processors include those manufactured by INTEL™, Advanced Micro Devices, Inc., Motorola, Inc., or Sun Microsystems. The network interface may be a telephone modem, a cable modem, a DSL modem, a wireless modem, or the like. It should be appreciated that the structure of this computer is provided as an example and is not intended to be limiting.

It is specifically contemplated that the content provider 50 may be connected to the internet 32, or other network 36, 38 at all times and therefore should be adapted to have a fail safe and hot-swappable structure. This will allow continued operation even in the event of isolated failures within the system.

While the content provider 50 has been described as a centralized computer at one physical location, those skilled in the art will appreciate that the content provider 50 could use other architectures to accomplish the same functionality. In another embodiment, content provider 50 could be a distributed system with multiple computer systems, each of them similar to the computer described above, at one physical location and linked together through a local area network (LAN). Each of the computer systems performs part of the tasks in a centralized computer system. In yet another embodiment, the content provider 50 could be a distributed system with multiple computer systems scattered across a number of physical locations but linked together through a wide area network (WAN). Each of the computer systems may also perform only one part of tasks of a centralized computer system.

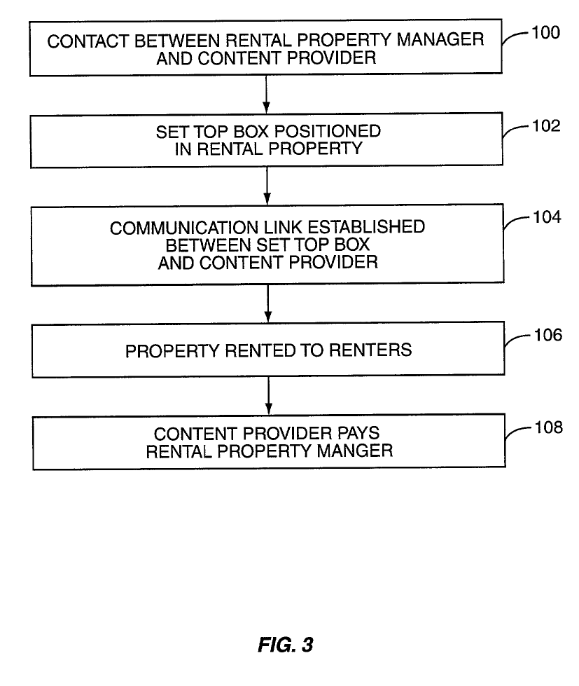

How this set top box 20 may be positioned within the rental property is part of the present invention. Heretofore, rental property such as condominiums had no effective way to provide content to the renters thereof without the rental property manager creating an account with the content provider. As used herein the term “rental property manager” includes rental property owners that manage their own property as well as third party managers that manage multiple dwellings on behalf of diverse landowners, such as Midgett Realty of Hatteras Island, N.C. Information about this entity can be found at http://www.midgettrealty.com. Promoting the set top box 20 and the accompanying service to such rental property managers lies within the scope of the present invention. A discussion follows with reference to FIG. 3.

Initially some contact is made between the rental property manager and the content provider 50 (block 100). This contact may be made through the rental property manager initiating contact as a result of learning of the content provider 50 through an advertising campaign, word of mouth recommendation or the like. Alternatively, this contact may be made at the initiation of the content provider 50.

The set top box 20 is placed in the rental property (block 102). As the rental property manager presumptively has occasional access to the premises, this should not be a problem. A communication link 24 is established between the set top box 20 and the content provider 50 (block 104). This may be done through the internet 32, a cable system 36, a satellite system 40, or some combination of these systems. An account need not be created at this time. Much as many homes are cable ready, or people have inactivated satellite systems, the communication link 24 may be quiescent at this stage of the process, although some preliminary tests may be performed to assure bi-directional communication with the content provider 50 is possible.

The rental property is rented to renters (block 106) as is conventional, and the renters may use the set top box 20 as is explained in greater detail below to purchase content from the content provider 50. Content provider 50 may collect revenue from this, as is explained in greater detail below, and provide some payment to the rental property manager (block 108). This may be a percentage of the revenue collected from that particular property, a flat fee for usage of the service, or other arrangement as the content provider 50 and the rental property manager contract. Alternatively, the payment may be made to the landowner in some instances where the rental property manager and the landowner are not the same entity. This provides a financial incentive for rental property managers to have these devices available in the rental property. Of course, given the competitive environment in which some of these rental property managers exist, the competitive edge offered by the services of the present invention may be enough to entice them to use the present invention.

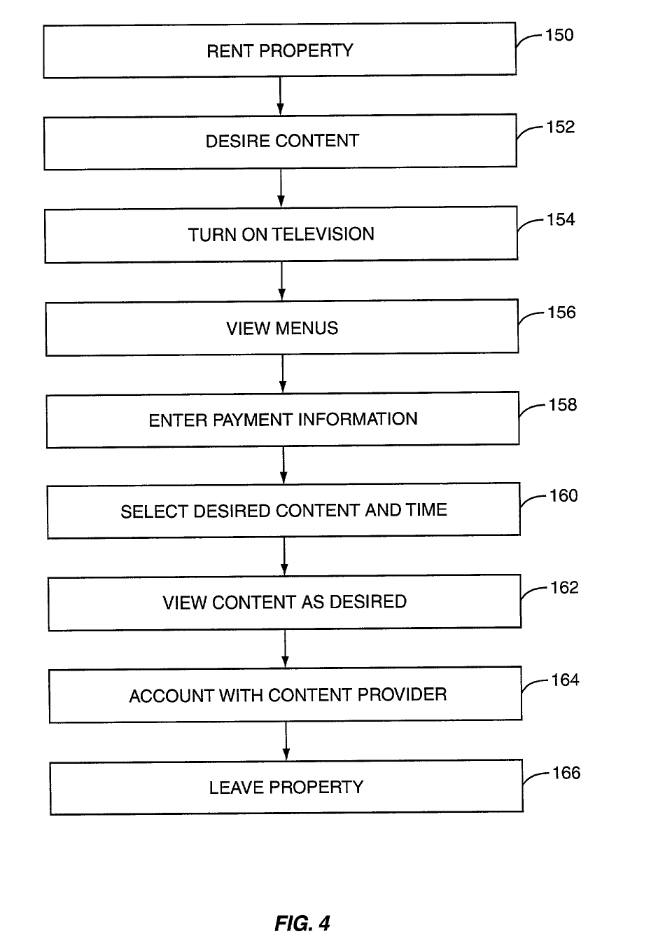

The present invention allows a renter of rental property to secure access to content as detailed with reference to FIG. 4. The renter may rent the property (block 150). In the contemplated embodiment, the renter rents mid-term rental property. Mid term rental is different from renting a hotel or motel room (short term rental property) and leasing a house for a more typical six months to a year or more (long term rental property). Specifically falling within this contemplated embodiment would be renting a rental condominium for a week at the beach or similar circumstances including bed and breakfast establishments. Note that while particularly contemplated for mid-term rental property, the present invention may also be used in both short and long term rental properties. However, other content providing services exist for such properties and the need is not as great in those contexts.

After renting the property and arriving thereat, the renter may desire content (block 152). The desire for content may include a desire for television content, movie content, internet access, video game content, or other sorts of comparable content. The renter may turn on the television 14 (block 154) and view menus on display 16 (block 156). These menus may be stored in memory local to the set top box 20 or continuously broadcast over the communication link 24 by the content provider 50 as needed or desired. These menus may set forth the sorts of packages that are available for the renter to purchase. In particular, the renter may view, for example, menus for a weekend or weeklong sports packages; news packages; premium movie packages; basic broadcast packages; and the like. Guides may also be included that indicate which shows are available at what times so that the renter may make an informed decision about in which packages the renter has an interest. Costs associated with each package may also be displayed.

The renter may then enter payment information (block 158). This may be done, for example, by swiping a magnetic card in payment acceptor 22. The magnetic card may be a bank card, a debit card, a credit card, or the like. Alternatively, the payment information may be entered with keypad 26, where the renter types out a credit card number, bank account number, or the like.

The renter may select the desired content package and, optionally, a time duration for the content to be provided (block 160). Thus, for example, the Buffalo Sabres's fan may select a hockey package for the week, knowing that all the Sabres's games are going to be played in that package. The renter may view the content as desired (block 162). Concurrent to some of these steps, the renter may account with the content provider 50 (block 164). Thus, if, for example, the renter provided a credit card number, the content provider 50 may verify that the credit card number is valid and charge the credit card.

After their stay, the renters eventually leave the property (block 166). At some point, the provision of the content terminates. This will be determined by how long a package and what type of package the renter purchased.

Note that where the renter has selected interactive content such as internet access or video game content, the set top box 20 may communicate with the content provider 50 in a bi-directional manner to pass the commands of the renter on to the content provider 50. Where internet access has been purchased, the content provider 50 acts as an Internet Service Provider (ISP) for the set top box 20, and may treat the set top box 20 as a dial up customer as is common in the ISP industry.

Note that the precise order of the events need not be as linear as indicated in FIG. 4, but rather may be rearranged as needed or desired. For example, the renter may select the desired package and then enter the payment information.

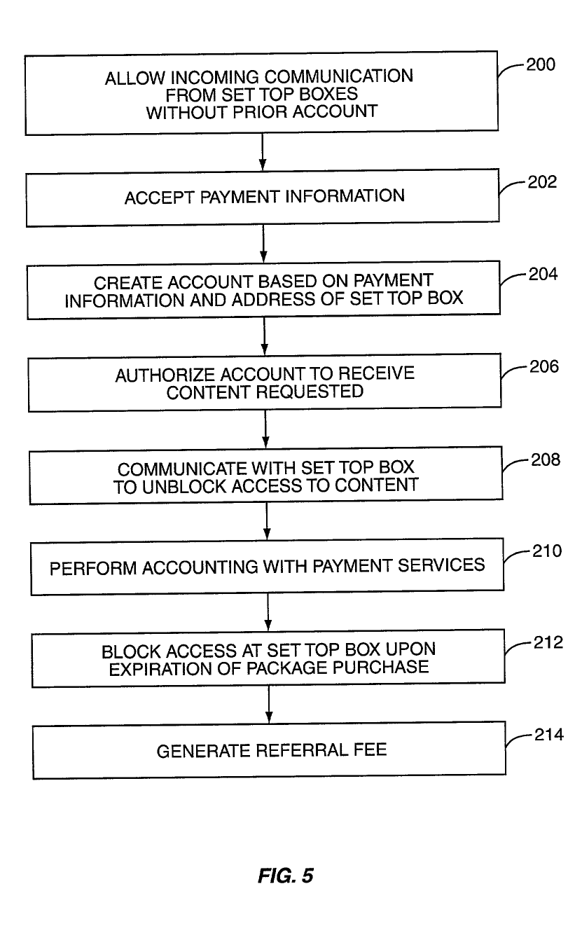

One of the benefits of this arrangement is that neither the renter, nor the rental property manager need have an account with the content provider 50 prior to the renter paying for the content. How this is effectuated is explained with reference to FIG. 5. The content provider 50 allows incoming communications from set top boxes 20 without requiring a prior account (block 200). If the set top box 20 has an IP address and uses the internet 32, this communication may take the form of a conventional TCP/IP communication. If the set top box 20 has a prior account, that is not a problem, but whereas currently DIRECTV, TIME-WARNER, and similar companies require consumers to commit to at least a month long contract, and frequently a year long contract for satellite service, the present invention does not require this. Also, whereas DIRECTV, TIME-WARNER, and similar companies require an existing account before pay-per-view services may be purchased, the present invention does not require such an account. As another alternative, the content provider may dynamically assign an IP address to the set top box 20 if desired.

The incoming communication may include some payment information provided by the renter, and the content provider 50 accepts this payment information (block 202). This payment information may comprise a credit card number, a debit card number, or the like as needed or desired. Content provider 50 may create an account based on the payment information and any address of the set top box 20 that was provided in the initial communication (block 204). Other account bases are also possible, but it is believed that the combination of the payment information and the address would provide a unique account number almost impervious to accidental duplication. Of course encryption may be used to protect any payment information if desired.

Content provider 50 may authorize the account to receive the content requested by the renter (block 206). As noted earlier, the renter may purchase one or more of a number of predetermined packages and this selection may be included in the communication of block 200. Content provider 50 communicates with the set top box 20 and unblocks access to the content bearing channels (block 208). An exemplary discussion of such a communication is set forth in U.S. Pat. 5,311,325, which is hereby incorporated by reference in its entirety.

Content provider 50 performs any needed accounting with the payment service (block 210). This may involve contacting a credit card clearing authority and making a charge to the credit card account provided by the renter, verifying that the card will support the charge without going over the limit, or the like as is well understood.

Content provider 50 eventually blocks access at the set top box 20 upon the expiration of the package purchased (block 212). Optionally, the content provider 50 may generate a referral fee for the landowner or the rental property manager (block 214) and periodically account with such an entity.

Note that the events of this process need not occur in the order listed, but rather may be rearranged as needed or desired.

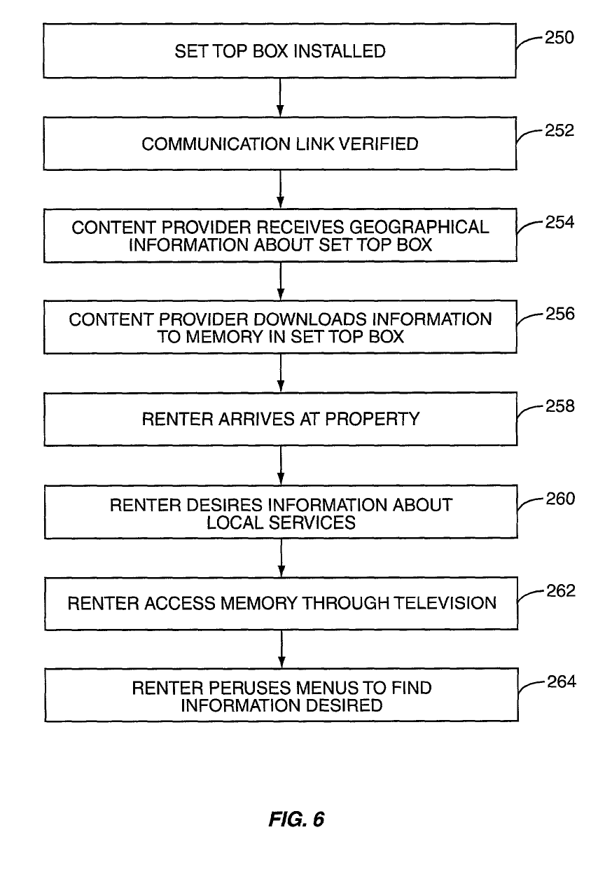

As many satellite services provide broadcast stations from large markets such as New York and Los Angeles, commercials present on such broadcasts may be inappropriate for the resort communities to which the present invention is targeted. Another aspect of the present invention comprises allowing renters to access information about local services, even though the advertisements and commercials available on the television bear a different geographical focus. Note that this does not preclude national advertisements from being displayed, but merely provides local merchants to target their advertising dollar. National advertising such as beer or airlines may certainly likewise purchase advertising from the content provider. This is explicated with reference to FIG. 6. Set top box 20 is installed at the premises (block 250). The communication link 24 is verified (block 252). Content provider 50 receives some geographical information about the set top box 20 (block 254). This may comprise a telephone number from which area code and/or city information may be derived or other technique as needed or desired. For example, in one embodiment, the set top box 20 may include a GPS receiver that outputs its present location for the purposes of this process. Likewise, the nature of the communication link 24 may also provide some indication of geographical location. For example, set top boxes 20 installed in certain geographic areas are instructed to access a certain web page or dial a certain telephone number when seeking access to content. These telephone numbers or web pages may be tied to radii of advertising if needed or desired.

Content provider 50 downloads information to the memory in the set top box 20 (block 256). This information may comprise commercials, web pages, or other advertisements arranged in menu format capable of being sorted alphabetically, by service type, or other sorting technique as desired. Eventually, a renter rents the property at which the set top box 20 is installed (block 258). This renter may desire information about local services (block 260), such as, for example, boat chartering.

The renter accesses the memory through the television 14 (block 262). This may involve tuning the television 14 to a special promotional channel or be a default screen that is visible whenever the television 14 is activated. The renter may then peruse menus or the like to find the desired information (block 264). The commercials or advertisements may be full video commercials, print advertisements viewable on the display 16, or web pages stored in a local memory. Again, the precise order of these events need not be as linear as suggested by the flow chart. Additionally, the existence of the communication link 24 allows this information stored in the local memory of the set top box 20 to be updated periodically as needed or desired.

Prior to the renter accessing the advertisements, the content provider may sell advertising time/space to merchants. Larger or longer ads may cost more than shorter or smaller ads. If the ad is being reused in multiple geographic areas, a discount may likewise be provided, or not as the content provider desires. As another alternative, the ads may be positioned at a web page that the set top box 20 periodically accesses for free. For example, a chamber of commerce may host a regional page that lists its members and their services as well as appropriate supplemental advertising.

As another embodiment, the renter may also be given the opportunity to purchase content at different rates depending on the level of advertising the renter desires. For high advertising content, the renter may pay a lower rate, but be subjected to many advertisements. For a higher rate, the renter may be subjected to fewer ads.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. A content delivery system comprising:
a reception module comprising a payment acceptor;
a content provider remotely positioned from said reception module and communicating with the reception module via a communication link; and
said content provider dynamically providing content to said reception module for limited periods of time upon receipt of payment through said payment acceptor and without a requirement of a pre-existing account between said content provider and said reception module.

2. The content delivery system of claim 1 wherein said communications link comprises a wireless communication link.

3. The content delivery system of claim 2 wherein said wireless communication link comprises a satellite communication link.

4. The content delivery system of claim 1 wherein said communication link comprises a wirebased communication link.

5. The content delivery system of claim 4 wherein said wirebased communication link comprises a cable communication link.

6. The content delivery system of claim 1 wherein said reception module comprises an identifying address.

7. The content delivery system of claim 6 wherein said identifying address comprises an IP address.

8. The content delivery system of claim 6 wherein said identifying address comprises a telephone number.

9. The content delivery system of claim 1 wherein said payment acceptor comprises a magnetic card reader.

10. The content delivery system of claim 1 wherein said payment acceptor comprises a keypad adapted to receive account information therethrough, said account information selected from the group consisting of: credit card account information, debit card account information, and bank account information.

11. The content delivery system of claim 1 wherein said reception module is positioned in rental property.

12. The content delivery system of claim 11 wherein said reception module is positioned in a rental condominium.

13. The content delivery system of claim 1 wherein said content provider delivers television content to said reception module.

14. The content delivery system of claim 1 wherein said content provider delivers video content to said reception module.

15. The content delivery system of claim 1 wherein said content provider delivers internet access to said reception module.

16. The content delivery system of claim 1 wherein said content provider delivers video games to said reception module.

17. The content delivery system of claim 1 wherein said reception module comprises a set top box.

18. The content delivery system of claim 1 wherein said reception module is integrated into a television.

19. The content delivery system of claim 1 wherein said content provider provides a plurality of predetermined content packages from which a consumer may select and for which the consumer may pay through said payment acceptor.

20. The content delivery system of claim 19 wherein said plurality of predetermined content packages comprise time limited packages.

21. The content delivery system of claim 19 wherein said plurality of predetermined content packages comprise topic limited packages.

22. The content delivery system of claim 21 wherein said topic limited packages comprise packages selected from the group consisting of: sports packages, news packages, movie packages, and broadcast packages.

23. The content delivery system of claim 1 wherein said reception module further comprises local memory.

24. The content delivery system of claim 23 wherein said local memory comprises 1 5 commercials relating to local business establishments.

25. A method of providing content to consumers, comprising:
positioning a reception module with a payment acceptor at a property;
selectively communicating with the reception module from a content provider;
receiving payment information from the reception module without a requirement for a preexisting account; and
delivering content over a communication link to the reception module.

26. The method of claim 25 wherein positioning the reception module at the property comprises positioning the reception module at a piece of rental property.

27. The method of claim 26 wherein positioning the reception module at the piece of rental property comprises positioning the reception module in a rental condominium.

28. The method of claim 25 wherein delivering content over the communication link comprises delivering content over a wireless communication link.

29. The method of claim 28 wherein delivering content over the wireless communication link comprises delivering content via a satellite.

30. The method of claim 25 wherein delivering content over the communication link comprises delivering content over a wirebased communication link.

31. The method of claim 30 wherein delivering content over the wirebased communication link comprises delivering content over a cable system.

32. The method of claim 25 further comprising receiving, at the content provider, an identifying address from the reception module.

33. The method of claim 32 wherein receiving an identifying address from the reception module comprises receiving a telephone number from the reception module.

34. The method of claim 32 wherein receiving an identifying address from the reception module comprises receiving an IP address from the reception module.

35. The method of claim 25 wherein receiving payment information from the reception module comprises receiving payment information from a magnetic card reader associated with the reception module.

36. The method of claim 25 wherein receiving payment information from the reception module comprises receiving payment information from a keypad associated with the reception module.

37. The method of claim 25 wherein receiving payment information from the reception module comprises receiving payment information from a remote control device.

38. The method of claim 25 wherein delivering content over the communication link to the reception module comprises delivering television content.

39. The method of claim 25 wherein delivering content over the communication link to the reception module comprises delivering video content.

40. The method of claim 25 wherein delivering content over the communication link to the reception module comprises delivering internet access.

41. The method of claim 25 wherein delivering content over the communication link to the reception module comprises delivering video games.

42. The method of claim 25 wherein positioning the reception module with the payment acceptor at the property comprises positioning a set top box at the property.

43. The method of claim 25 wherein delivering content over the communication link comprises delivering one of a plurality of predetermined content packages from which a consumer may select and for which the consumer may pay through the payment acceptor.

44. The method of claim 43 wherein delivering one of the plurality of predetermined content packages comprises delivering one of a plurality of time limited packages.

45. The method of claim 43 wherein delivering one of the plurality of predetermined content packages comprises delivering one of a plurality of topic limited packages.

46. The method of claim 25 further comprising presenting advertisements for local establishments to a potential consumer through the reception module.

47. A method of generating revenue, comprising:
creating a system as set forth in claim 1; and
promoting said system to rental property managers.

48. The method of claim 47 wherein promoting said system to rental property managers comprises promoting said system to rental property owners.

49. The method of claim 47 wherein promoting said system to rental property managers comprises promoting said system in resort communities to managers of rental condominiums.

50. The method of claim 25 further comprising dynamically assigning an IP address to the reception module from the content provider.
